(19) United States
(12) Patent Application Publication
(10) Pub. No.: US 2003/0097899 A1
(43) Pub. Date: May 29, 2003

(54) Return device for the pedals of a motor vehicle

(76) Inventors: Andree Burgstaler, Dielingen (DE); Jan Dutz, Damme (DE); Simone Patzold, Cappeln (DE)

Correspondence Address: McGlew & Tuttle, Scarborough Station, Scarborough, NY, 10510-0827, US

(21) Appl. No.: 10/240,605

(22) PCT Filed: Jan. 31, 2002
(86) PCT No.: PCT/DE02/00330

(30) Foreign Application Priority Data
Feb. 2, 2001 (DE) 10105265.0

(51) Int. Cl. G05G 1/14

(52) U.S. Cl. 74/560

(57) ABSTRACT

A resetting device for pedals of a motor vehicle is shown, which is shown [“provided”-Tr.Ed.] with a spring element 6, which is fixed on a mount 9 at the pedal 1, on the one hand, and, on the other hand, at a corresponding mount 10, in which at least one spring-loaded friction element 12 with at least one friction surface pair 13, 14 is arranged according to the present invention between the pedal 1 and the body.

The present invention pertains to a resetting device for pedals of a motor vehicle, which pedals are mounted on an axis of rotation, with a spring element, which is fixed on a mount at the pedal, on the one hand, and, on the other hand, on a mount that is rigidly connected to the body.

Various designs of pedals of a motor vehicle for actuating the brake, clutch and gas with the features forming the class have been known from the state of the art. The spring elements usually comprise here tension springs, which are hung with one of their ends into a mounting device at the pedal and the other free end is articulated to a hook or the like on the body. Besides tension springs, resetting devices equipped with compression springs have also been known, especially in the case of resetting devices for electronic module units for scanning the position of the gas pedal and transmitting the data thus obtained to downstream assembly units (E gas modules). Due to the springs used, there is a hysteresis effect between the pedal actuation by the user and the resetting movement by the articulated spring, which is decisive for the feeling of actuation during the use of the pedal arrangement in question. The hysteresis occurring and consequently the pedal feel resulting therefrom is set in the resetting devices known from the state of the art by the predetermined springs and is consequently not adjustable or variable. Moreover, the resetting devices of this class do not have the possibility of increasing the hysteresis between the two actuation directions of the pedal in question.

The object of the present invention is therefore to improve a resetting device of the type corresponding to this class for pedals of motor vehicles such that the hysteresis between the actuation directions of the pedal, which is caused by the resetting springs used, can be made variable with a simple design and in an inexpensive manner.

This object is accomplished by the technical teaching of the independent claims. Embodiments of the present invention are described in the subclaims following the description.

Thus, a possible solution according to the present invention is seen in that at least one spring-loaded friction element with at least one friction surface pair, which comprises mutually corresponding friction surfaces, is arranged between the pedal and the body. According to another suggestion, provisions are made, moreover, for arranging between the pedal and the body at least one spring-loaded friction element with at least one friction surface pair, which comprises mutually corresponding friction surfaces, which form an acute angle of skew with the plane of rotation of the pedal.

In conjunction with the friction surfaces, which are designed, e.g., as planes or as surfaces with a curved shape, the friction element guarantees an increase in the hysteresis between the actuation direction of the pedal and its resetting movement. Regardless of the resetting springs used, differently dimensioned springs can be used here in the friction element without problems, and the rates of the springs guarantee, in conjunction with different angles of skew, an individual adaptation of the feeling of actuation of the pedal to different requirements. In addition, an additional damping of the resetting movement of the pedal can be brought about by the design according to the present invention.

It proved to be particularly advantageous in this connection for the angle of skew between the plane of the friction surface and the plane of rotation of the pedal to have a value in the range of 0.5-10°.

Provisions are made in an inexpensive design for the friction element to be formed from two cylindrical sections of different diameters, which adjoin one another, wherein the cylindrical section with the smaller diameter is designed as a mount, which receives a compression spring, and the cylindrical section with the larger diameter has the friction surface on its free front surface facing away from the other section. According to the present invention, the cylindrical section with the larger diameter may be a cylinder cut off obliquely as well as a circular cylinder cut off obliquely.

This design protects, on the one hand, the compression spring for generating the frictional forces from buckling movements and, on the other hand, the necessary friction surface on the front side of the cylindrical section with the larger diameter can be dimensioned as a sufficiently large surface, and a compact, space-saving design of the entire friction element can be guaranteed. In the design being described, the friction element is mounted, if necessary, in a pot-shaped mount, which is designed as an integral component of the corresponding motor vehicle pedal, and the second friction surface corresponding to the friction surface of the friction element is arranged on the side of the pedal, e.g., on a holding device for the said pedal.

An exemplary embodiment of the present invention will be explained in greater detail below on the basis of the drawings attached. In the view in the figures, individual areas were shown only as details, so that a synoptic view of the motor vehicle pedal including its mounting or mount at the body is not shown.

In the drawings,

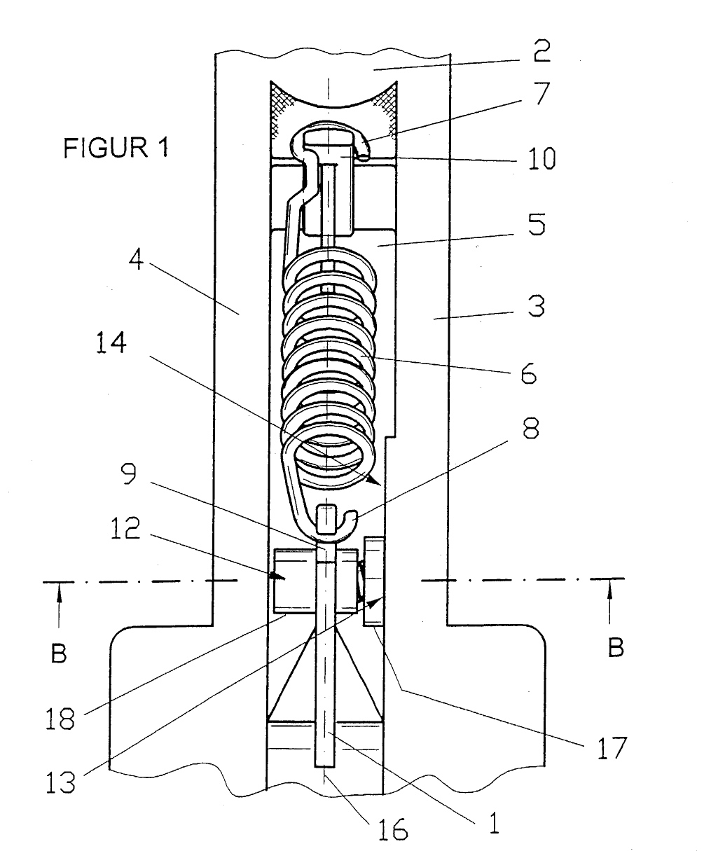

FIG. 1 shows a perspective front view of the resetting device according to the present invention,

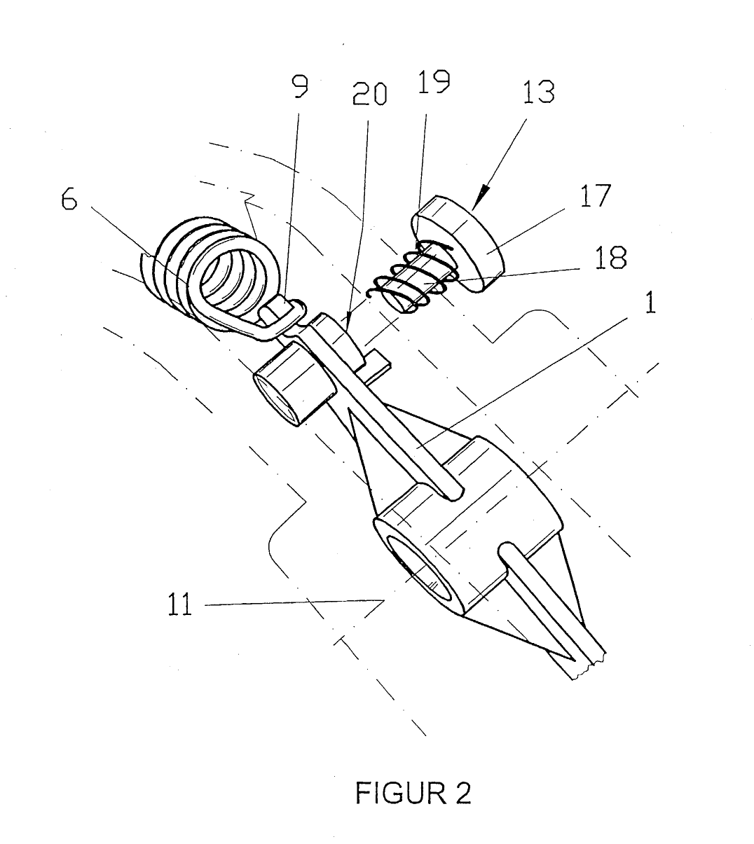

FIG. 2 shows an exploded view of the resetting device from FIG. 1 from another angle of view, and

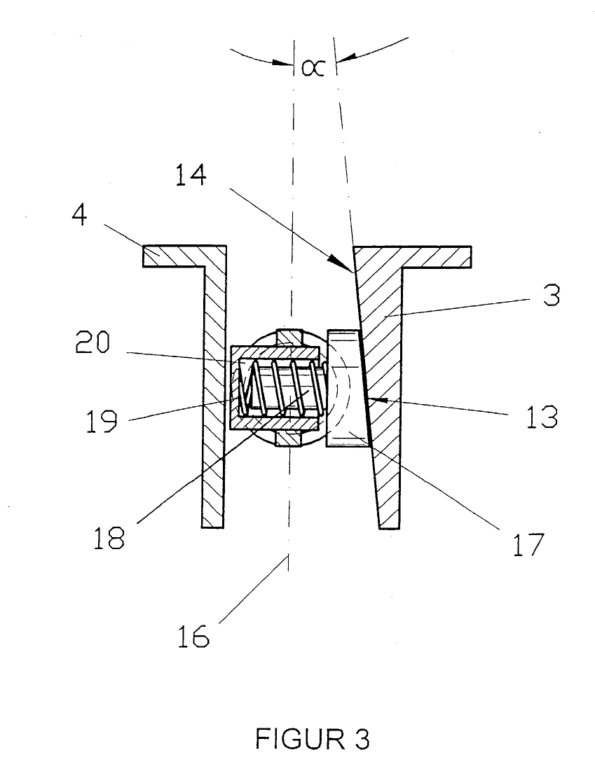

FIG. 3 shows a sectional view along line B-B in FIG. 1.

FIG. 1 shows the top part of a pedal 1, preferably for the actuation of an E gas module. The pedal 1 is mounted here in a pedal bracket 2 connected to the body of the motor vehicle. In the exemplary embodiment being shown, the pedal bracket 2 has two lateral walls 3, 4, which define between them an elongated hole 5, in which the upper part of the pedal 1 is accommodated, on the one hand. Moreover, the slot 5 also accommodates a spring element 6 designed as a tension spring for generating resetting forces for the pedal 1. The spring element 6 has hooks 7, 8 at its free ends for articulating the spring element 6 to a pedal-side mount 9, on the one hand, and to a body-side mount 10, on the other hand. During the rotation of the pedal 1 around an axis of rotation 11 located between the walls 3 and 4 (see FIG. 2), the spring element 6 is elongated and pulls the pedal 1 back into its starting position after the end of the deflecting movement due to its spring action.

The resetting device shown is equipped according to the present invention with a spring-loaded friction element 12. The friction element 12 is arranged between the pedal 1 and the wall 3 in the embodiment being shown, and the spring 19 (see FIG. 2 or 3) of the friction element 12, being a compression spring, generates frictional forces in a friction surface pair with the corresponding friction surfaces 13 and 14. The friction surface 13 is now on the outer side of a cylindrical section 17 of the friction element 12. The associated friction surface 14 is provided on the inner side of the wall 3. The friction surface 14 forms a bevel (see FIG. 3), which forms an acute angle α with the plane of rotation 16, which is indicated by dash-dotted line in FIG. 3 to illustrate its position. During the rotation of the pedal 1 and a displacement of the friction element 12 along the friction surface 14, which displacement is associated therewith, the frictional forces generated by the friction element 12 become stronger as a consequence of the reduction of the distance between the friction surface 14 on the wall 3 and the plane of rotation 16 of the pedal 1, because the spring action of the compression spring 19 of the friction element 12 increases hereby.

The design of the friction element 12 is shown in FIG. 2 for illustration (however, without the friction surface 14). The friction element 12 has cylindrical sections 17 and 18. The cylindrical section 18 has a smaller diameter than the adjoining section 17, at the free end of which, which faces away from the section 18, the friction surface 13 is located. The cylindrical section 18 is used to receive a compression spring 19, which is supported on a front surface of the cylindrical section 17, on the one hand, and, on the other hand, at the bottom of a mounting hole 20, which is prepared in the pedal body in the upper part of the pedal 1 adjacent to the mount 9 for the spring element 6, the mounting hole 20 being provided in a pot-shaped thickened part of the pedal body.

To generate frictional forces of varying strengths, this compression spring 19 may be provided in different designs and with different rigidities in the friction element. Moreover, the design of the oblique friction surface 14 offers the possibility of making the pedal feel during the pivoting of the pedal correspondingly variable by increasing or decreasing the friction forces. The skew of the friction surface 13 on the friction element 12 is adapted to the friction surface 14. Another possibility of varying the properties of the friction surface is to correspondingly select the friction pair, i.e., the material of the surfaces that are in contact with one another.

List of reference numbers

1 Pedal

2 Pedal bracket

3 Wall

4 Wall

5 Slot

6 Spring element

7 Hook

8 Hook

9 Mount

10 Mount

11 Axis of rotation

12 Friction element

13 Friction surface

14 Friction surface

16 Plane of rotation

17 Section

18 Section

19 Compression spring

20 Mounting hole

1. Resetting device for said pedals (1) of a motor vehicle, which said pedals (1) are mounted on a said axis of rotation (11), with a said spring element (6), which is fixed on a said mount (9) at the said pedal (1), on the one hand, and, on the other hand, on a said mount (10), which is rigidly connected to the body,
characterized in that
at least one said friction element (12) with at least one said friction surface pair (13, 14), which comprises corresponding friction surfaces, is arranged between the said pedal (1) and the body.

2. Resetting device for said pedals (1) of a motor vehicle, which said pedals (1) are mounted on a said axis of rotation (11), with a said spring element (6), which is fixed on a said mount (9) at the said pedal (1), on the one hand, and, on the other hand, on a said mount (10), which is rigidly connected to the body,
characterized in that
at least one said spring-loaded friction element (12) with at least one said friction surface pair (13, 14), which comprises corresponding friction surfaces forming a said acute angle of skew (α) with the said plane of rotation (16) of the said pedal (1), is arranged between the said pedal (1) and the body.

3. Resetting device in accordance with claim 2,
characterized in that
the said angle of skew (α) has a value in the range of 0.5-10°.

4. Resetting device in accordance with claim 2 or 3,
characterized in that
the said friction element (12) is formed from two said, mutually adjacent cylindrical sections (17, 18) of different diameters, wherein the said cylindrical section (18) accommodates a said compression spring (19) and the said cylindrical section (17) of the larger diameter has a said friction surface (13) on its front surface facing away from the said other section (18), and the friction element is mounted in a said mounting hole (20) of the said pedal (1).
